(19) United States
(12) Patent Application Publication
(10) Pub. No.: US 2004/0062596 A1
(43) Pub. Date: Apr. 1, 2004

(54) Apparatus and method for joining tubulars

(75) Inventors: Van T. Walworth, Lebanon, TN (US); David B. Hook, Franklin, TN (US); Mark Bowsher, Richmond, TX (US); Ashish Jain, Houston, TX (US)

Correspondence Address: PAUL S MADAN, MADAN, MOSSMAN & SRIRAM, PC, 2603 AUGUSTA, SUITE 700, HOUSTON, TX, 77057-1130, US

(73) Assignee: Star Pipe Products, Inc.

(21) Appl. No.: 10/259,337

(22) Filed: Sep. 27, 2002

(51) Int. Cl. B25G 3/20

(52) U.S. Cl. 403/373

(57) ABSTRACT

A preferred joint restraint includes a dampening force and a restraining force to control relative movement between a pad and gland and between the gland and bolt, respectively. The preferred restraint includes a gland, pads, and bolts. Preferably, a flexible member disposed in the pad selectively provides the dampening and retaining force. A preferred joint restraint also includes a pad and a bolt that coact to provide a controlled wedging action. The wedging action supplies supplemental tooth penetration and/or enhanced clamping force that stabilizes a shifting tubular member (pipe). A preferred tooth arrangement for a restraint pad produces an intermittent penetration pattern in the pipe. A preferred spacing member for a restraint tunes a clamping force generated by the restraint to accommodate variations in pipe geometry and/or materials. A preferred restraint is arranged according to a method that uses pipe expansion to provide an enhanced gripping action.

### CROSS-REFERENCE TO RELATED APPLICATIONS

None.

### BACKGROUND OF THE INVENTION

1. Field of the Invention

The present invention relates to joint restraints for tubular members. More particularly, the present invention relates to systems and methods for controlling the relative movement of components making up a joint restraint and controlling the clamping force applied to tubular members.

2. Description of the Related Art

Joint restraints are typically used to couple two axially-aligned tubular members such as pipes. A conventional joint restraint includes an annular body or gland fitted with a plurality of evenly spaced pads or wedges. Each pad has an associated bolt that, when rotated, urges the pad radially inward from a retracted position to an extended position. During extension, the teeth projecting out of the pad contact an outer surface of a first tubular member. The gland becomes substantially fixed onto the first tubular member as bolt rotation generates a clamping force that causes the teeth to penetrate or bite into the first tubular member. Mechanisms, such as a bolt or fastener, are used to connect the gland to a flange formed on a second pipe. Thus, a mechanical connection is established between the two tubular members.

Conventional joint restraints have certain drawbacks. For example, in many conventional joint restraint arrangements, the pads are disposed in pockets formed within the gland. To prevent relative movement between the gland and the pad during, for example, shipment or handling, a frangible material such as paint, epoxy, or wax is used to retain the pad in a retracted position within the pocket. Once the pad is extended, however, the frangible material is disturbed in such a way that it can no longer effectively retain the pad. In certain other joint restraint arrangements, the teeth may produce penetration or incision patterns that affect the integrity of the tubular member. Still other joint restraint arrangements are not readily adapted to accommodate variations in tubular member material or geometry.

The present invention addresses these and other shortcomings of conventional joint restraint arrangements.

### SUMMARY OF THE INVENTION

The present invention provides a robust joint restraint that incorporates features and arrangements that enhance joint restraint reliability and produce a stable clamping force for joining tubular members. The invention may be advantageously applied to a restraint that has a gland that fits around a tubular member, a plurality of pads adapted to apply a clamping force on the tubular member, and a plurality of bolts that move the pads from a retracted position to an extended position.

In a first aspect, the present invention provides selective and controlled relative movement between the pad and the gland of the joint restraint. The relative movement between the pad and the gland is controlled by use of a dampening force. This dampening force can be generated by a mechanical device, a chemical, or by known natural forces such as a magnetic field. In a preferred embodiment, a flexible member associated with the pad applies a compressive force against an interior surface of the gland. This flexible member dampens relative movement between the pad and the gland. Further, the flexible member can extend into and be captured by a recess formed into the interior surface. The material and configuration of the flexible member can be adjusted to provide a selective amount of dampening force.

In a second aspect, the present invention provides a retaining device that permits a controlled retraction and extension of the pad by the bolt. The retaining device selectively connects the pad to an end of the bolt. In a preferred embodiment, the flexible member is a deformable ring that nests within a cavity formed in the pad. The flexible member surrounds a portion of the bolt when the bolt is inserted into the pad and thereby connects the pad to the bolt.

In a third aspect, the present invention provides an articulated wedging interface between the pad and the bolt. This wedging interface includes a frustoconical section formed on a tip of the bolt and a generally planar surface on the pad. Relative movement between the tubular member and the pad causes the pad to wedge against the bolt tip in a controlled fashion. This action can cause supplemental penetration of the teeth into the surface of the tubular member and/or generate an enhanced clamping force.

In a fourth aspect, the present invention provides a tooth arrangement that enhances the clamping action of the pad. A preferred arrangement includes a plurality of teeth that are offset from the edges of the pad with a landing. Additionally, a predetermined amount of spacing is provided between the teeth in order to produce a discontinuous or intermittent penetration or incision pattern on the outer surface of the tubular member. This incision pattern reduces the risk that the incisions will affect the structural integrity of the tubular member. Preferably, at least two teeth are substantially aligned along a first circumference. In a related embodiment, a third tooth is substantially aligned on a second circumference that is different from said first circumference to form a tripod arrangement.

In a fifth aspect, the present invention provides a spacing member that tunes the clamping force generated by a coupling to accommodate variations tubular member diameters or materials.

In a sixth aspect, the present invention provides a method of designing and arranging a joint restraint that uses pipe expansion to provide an enhanced gripping action. For a preferred joint restraint, the geometry of the gland, the pad and the teeth are set such that pre-characterized pipe expansion, in addition to pad extension, causes a predetermined amount of tooth penetration. In one preferred method, the geometry of the joint restraint is based on target tooth penetration at predetermined operating conditions. Preferably, an initial penetration of about 3% to 10% is obtained by pad teeth at about 10%-25% percent of a rated working pressure of the pipe. Further, it is preferred that at the rated working pressure, the tooth penetration be generally in the range of 30% 70%.

It should be understood that examples of the more important features of the invention have been summarized rather broadly in order that detailed description thereof that follows may be better understood, and in order that the contributions to the art may be appreciated. There are, of course, additional features of the invention that will be described hereinafter and which will form the subject of the claims appended hereto.

### DESCRIPTION OF THE FIGURES

For a detailed description of an embodiment of the invention, reference will now be made to the accompanying drawings wherein:

FIG. 1 illustrates a schematic side view of a preferred joint restraint made in accordance with the present invention;

FIG. 2A illustrates an end view of a section of a preferred joint restrain made in accordance with the present invention;

FIG. 2B illustrates a sectional view B-B taken from FIG. 2A;

FIG. 3A illustrates an end view of a preferred pad made in accordance with the present invention;

FIG. 3B illustrates a bottom view of a preferred pad made in accordance with the present invention;

FIG. 3C graphically illustrates an exemplary penetration or incision pattern formed on a tubular member surface by a preferred pad made in accordance with the present invention;

FIG. 4A illustrates a side view of a preferred bolt made in accordance with the present invention;

FIG. 4B schematically illustrates a tip of a preferred bolt made in accordance with the present invention;

FIG. 5A illustrates a preferred flexible member made in accordance with the present invention;

FIG. 5B illustrates a preferred flexible member made in accordance with the present invention that has been deformed;

FIG. 6A illustrates an exemplary spacer member functionally disposed in an embodiment of a joint restraint made in accordance the teachings of the present invention;

FIG. 6B illustrates an exemplary spacer member made in accordance the teachings of the present invention;

FIG. 7A graphically illustrates test data relating to pressure tests conducted on 6″ DR18 PVC Pipe;

FIG. 7B graphically illustrates test data relating to pressure tests conducted on 12″ DR18 PVC Pipe;

FIG. 7C graphically illustrates one preferred relationship between joint configuration and working pressure; and

FIG. 8 illustrates an exemplary joint restraint geometry relevant to a preferred method of arranging a joint restraint.

### DETAILED DESCRIPTION OF THE INVENTION

The present invention relates to devices and methods providing rugged and cost-effective joint restraint that provides an enhanced clamping force for joining tubular members. The present invention is susceptible to embodiments of different forms. There are shown in the drawings, and herein will be described in detail, specific embodiments of the present invention with the understanding that the present disclosure is to be considered an exemplification of the principles of the invention, and is not intended to limit the invention to that illustrated and described herein.

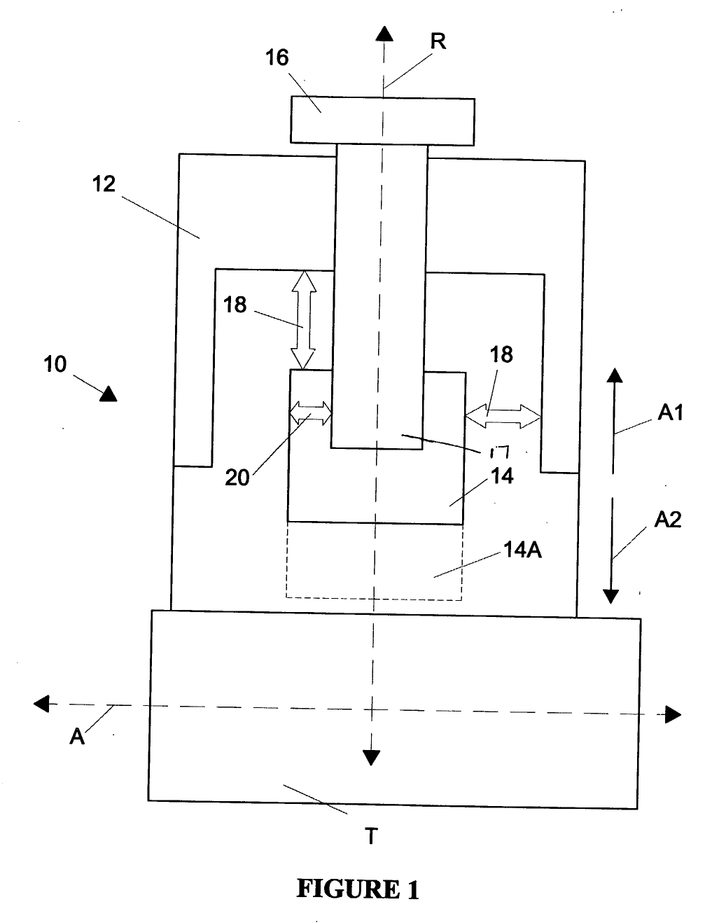

Referring initially to FIG. 1, there is schematically illustrated an exemplary coupling 10 made in accordance with the present invention. The coupling 10 is shown positioned about an end of a tubular member T. In the following description of the advantageous features of the coupling 10, the term “radial” movement denotes movement along axis R and “axial” movement denotes movement along axis A. Further, terms such as “downward” movement or “extension” are defined as movement in the direction of arrow A2 and terms such as “upward” movement or “retraction” are defined as movement in the direction of arrow A1.

The coupling 10 includes a gland 12, a pad 14 and a bolt 16. A preferred coupling 10 is provided with (a) a dampening device 18 that controls relative movement between the pad 14 and the gland 12; and (b) a retaining device 20 that selectively connects the pad 14 to the bolt 16. It will, of course, be understood that the pad 14 and bolt 16 are merely representative of a plurality of pads and bolts that are circumferentially arrayed within the gland 12.

The pad 14 is adapted to apply a clamping force onto the outer surface of the tubular member T. The pad 14 is ordinarily disposed within the gland 12 and can move between the shown retracted position and an extended position 14a (shown in phantom lines). While retraction and extension are desired forms of movement, the pad 14 and gland 12 can be susceptible to undesired relative movement. For example, the pad 14 could vibrate or chatter within the gland 12. Moreover, the pad 14 could simply fall out of the gland 12. The dampening device 18, however, dampens or reduces the likelihood and/or magnitude of such movement. In a preferred arrangement, the dampening force 18 applies a dampening force each time the pad 14 moves into the retracted position. Thus, in contrast to the temporary force produced by frangible materials, the dampening device 18 provides a substantially persistent force. That is, the dampening device 18 controls relative movement throughout at least one cycle wherein the pad 14 moves into a retracted position or state after being moved to an extended state.

The dampening force provided by the dampening device 18, however, can be selectively applied to other situations or conditions. For example, the dampening force may be applied while the pad 14 is in the extended position or moves between the extended and retracted positions or states. In the context of the present invention, it should be understood that the term movement between a retracted position or state and an extended position or state encompasses movement from a retracted position to an extended position and movement from an extended position to a retracted position.

The bolt 16 moves the pad 14 between the retracted and extended state and applies a downward axial force that urges the pad 14 against the tubular member T. The bolt 16 has an end portion 17 that selectively engages or coupled to the pad 14 by the retaining device 20. By substantially fixing the pad 14 to the bolt 16, the retaining device 20 can stabilize the motion of the bolt 16 and pad 14 during extension of the pad 12. Moreover, because of the bolt 16 is coupled to the pad 14, the retaining device 20 enables the retraction or upward movement of the pad 14. In a preferred arrangement, the movement of the bolt 16 activates the retaining device 20. For example, the downward movement of the bolt 16 can activate the retaining device 20 by applying a first predetermined amount of thrust. The retaining device 20 can fix the pad 14 to the bolt 16 until it is deactivated by, for example, upward movement of the bolt 16 that applies a second predetermined amount of thrust.

The dampening device 18 and retaining device 20 can be any number of devices, systems, mechanisms and materials. Exemplary forces and associated devices include, but are not limited to: frictional or compressive forces provided by devices such as deformable members (e.g., coil springs, gaskets or o-rings); a locking force utilizing interlocking members using a detent mechanism (e.g., a detent ball biased with a spring) or common devices such as VELCRO®; and a chemical force provided by suitable adhesives and resins that remain sticky or viscid for a predetermined time; e.g., until shipment/installation or throughout service life. In these arrangements, it will be seen that there is some form of direct or indirect contact between the pad 14 and the gland 12 and/or bolt 16. Such type of contact, however is not necessary. For example, the dampening device 18 can produce a magnetic force provided by a magnetic field (e.g., by magnetizing portions of the pad 14 and the gland 12 and/or bolt 16). In still another arrangement, a vacuum or negative pressure may be induced between the pad 14 and the gland 12 and/or bolt 16 (e.g., by using a vacuum chamber).

It should also be appreciated that the dampening force provided by the dampening device 18 need not be applied strictly between the gland 12 and the pad 14. For example, the bolt may be used as an intermediate component through which the dampening device 18 acts on the pad 12. Preferably, however, the dampening force is not applied via the bolt 16. Having the dampening device 18 independent of the bolt 16 permits greater flexibility in the manufacturing, assembly, shipment and installation of the coupling 10. For example, the bolts 16 can be shipped separately from the gland 12 and pads 14 while still providing controlled relative movement between the gland 12 and pad 14.

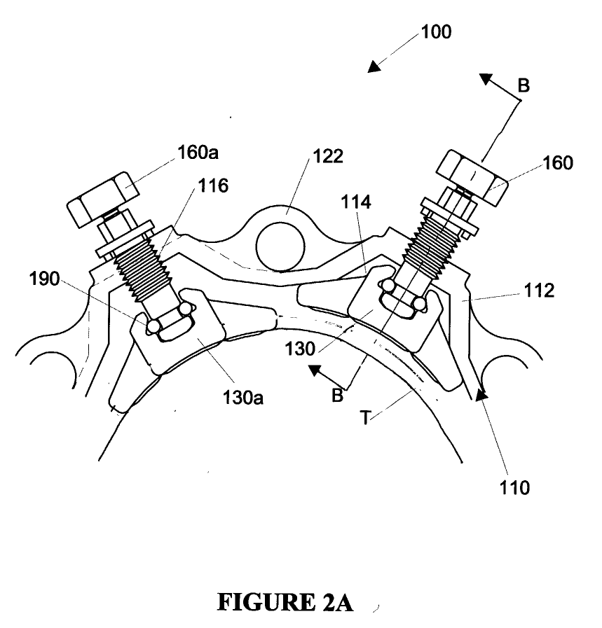

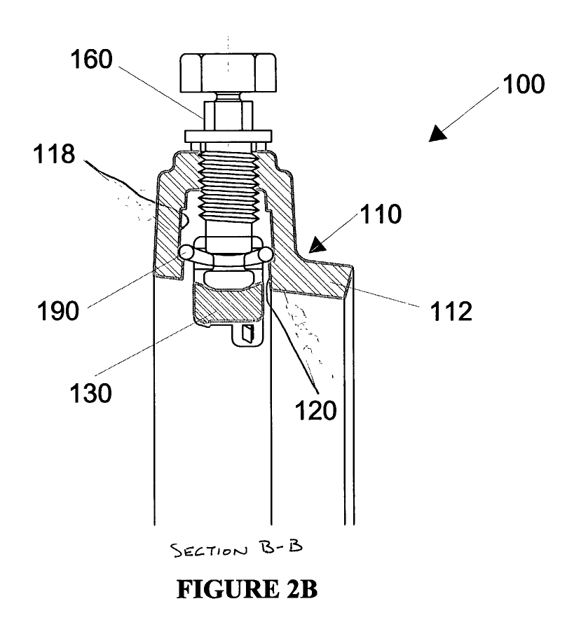

Referring now to FIGS. 2A-B there is shown a preferred embodiment of a restraint 100 made in accordance with the present invention. The preferred restraint 100 includes a gland 110, a pad 130, a bolt 160, and a flexible member 190. The pad 130 and the bolt 160 are shown in their retracted position. For convenience, a pad 130a and bolt 160a are shown in an extended position. In this extended position, pad 130a is shown engaging a tubular member T.

The gland 110 is of substantially conventional design and includes a generally ring-like body 112. The body 112 includes a pocket 114, a threaded radial bore 116, a recess 118 and an interior surface 120. The body 112 also includes known features such as flanges 122 and through holes that are of conventional design and known to those of ordinary skill in the art. Such features will not be discussed in detail. The pocket 114 is generally formed to receive the pad 130 and the threaded radial bore 116 is formed complimentary to the threads formed on the bolt 160. The recess 118 is a depression along the interior surface 120 that is shaped to receive the flexible member 190 in a manner to be described later.

Referring now to FIGS. 2A to 4A-B, the pad 130 is adapted to apply a clamping force onto the tubular member T. The pad 130 includes a chamber 132, a clamping surface 138, teeth 140a-c and a landing 142. The chamber 132 includes a first portion 134, a second portion 136 for receiving the flexible member 190, and a bearing surface 139. The first portion 134 is a generally radially aligned cavity that is shaped to receive the bolt 160. The second portion 136 is a channel-like opening that is elongated along the axis A (FIG. 1). The bearing surface 139 includes a planar section 139A and a sloped section 139B that coact with the bolt 160 in a manner described below.

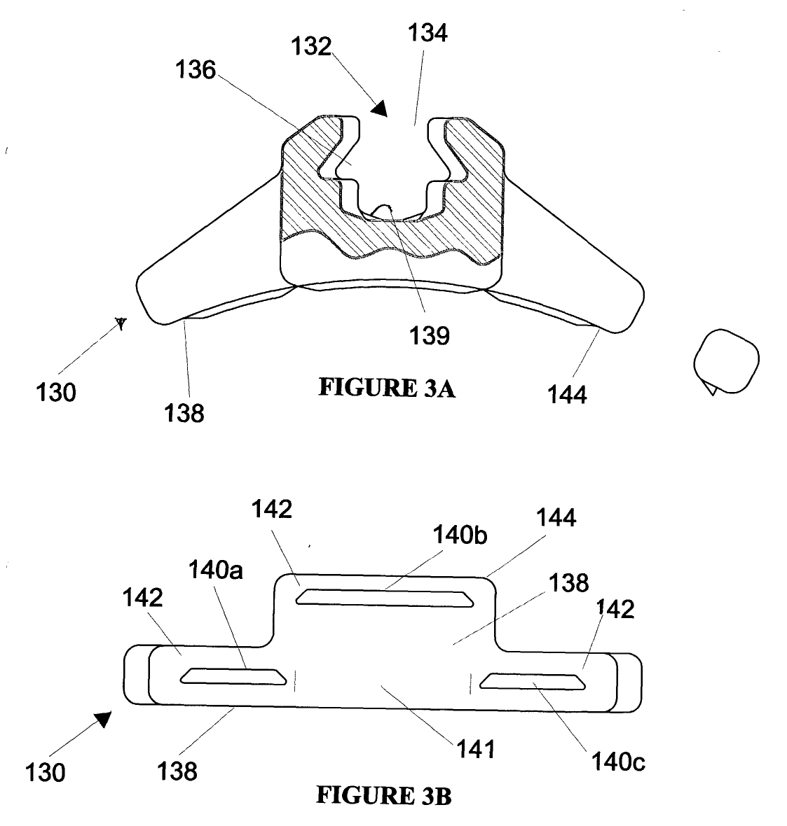

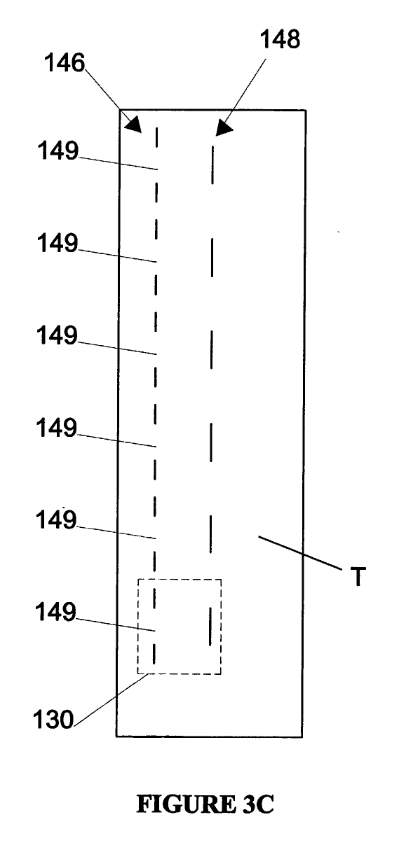

The teeth 140a-c are adapted to penetrate and grip the tubular member T. The teeth 140a-c, which project out of the clamping surface 138, have a predetermined spatial interrelationship that enhances the grip or clamping force applied to the tubular member T. In a preferred arrangement, the teeth 140a-c are arranged to produce intermittent or discontinuous penetration into the surface of the tubular member T along a functional circumference. That is, a row of teeth can be arranged along one circumference or can be arranged along two or more circumferences and function effectively as one circumference because of their dimensions or proximity. For example, a space 141 is provided between teeth 140a and 140c. The benefits of this arrangement are described below. Further, the teeth 140a-c are arranged in a tripod-fashion to enhance stability of the pad 140. To minimize undue pressure on the pad, the axial offset or distance between teeth 140a,c and teeth 140b is at least one-half of the bolt diameter and no greater that twice the bolt diameter. In certain embodiments, however, other offsets may be adequate to provide bolt stability and optimal pad pressure distribution. Although FIG. 3B shows that the lengths of teeth 140a and 140c do not overlap the length of tooth 140b, such an arrangement is not necessary to obtain the benefits of the present invention.

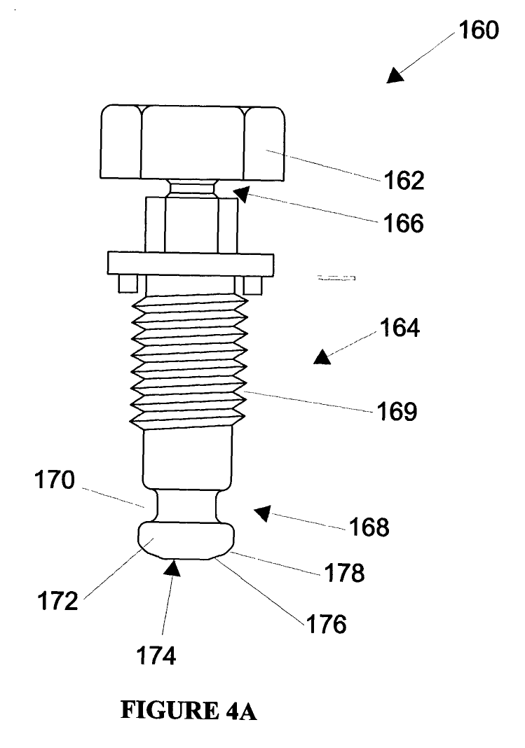

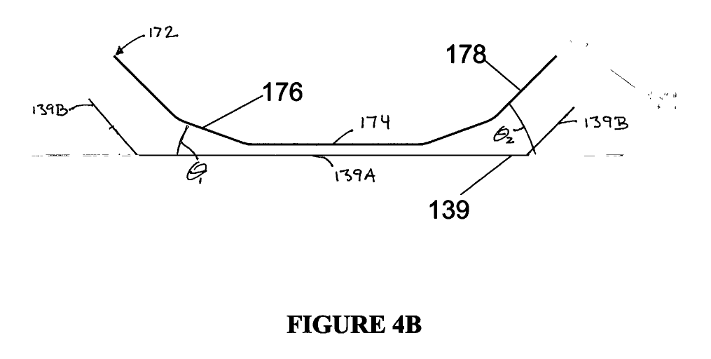

Referring now to FIG. 3C, there is shown a portion of a tubular member T “unwrapped” or “unrolled” as it were to an illustrate full circumferential contact pattern of the teeth 140a-c associated with six pads. Representative teeth 140a,c produce the indentations or bite pattern designated 146 and representative tooth 140b produces the indentations or bite pattern designated with numeral 148. As can be seen, the bite of the teeth 140A,C does not create a substantially continuous line of penetration or incision into the tubular surface T. Rather the bite pattern includes spacing 149 that interrupts the incision made by the teeth of one pad 130 into the tubular member surface. It is believed that staggering of the pad teeth as described above minimizes a risk that a tubular member T will suffer a structural failure along the line or penetration or incision. Referring back to FIG. 3B, landings 142 provide a space or an area into which the material of the tubular member T can flow as the teeth 140a-c penetrate into the surface of the tubular member T. The landing 142 is a generally planar portion on the clamping surface 138 that separates the teeth 140a-c from a contact edge 144. The contact edge 144 comes into contact with the tubular member T upon full penetration of the teeth 140a-c. It is preferred that the contact edge 144 is rounded to reduce the stress concentrations that may occur during contact of the contact edge 144 and the surface of the tubular member T. Referring now to FIG. 4A there is shown a preferred bolt 160 for actuating the pad 130. The bolt 160 is generally of conventional design and is used to move the pad 130 between a retracted and extended position. The bolt 160 includes a head 162, a shank 164, and a torque limiting section 166. The head 162 and torque limiting section 166 are of conventional design and will not be described in further detail.

Referring now to FIGS. 3A and 4A-B, the shank 164 includes a threaded portion 169 that is complementary to the radial bore 116 of the gland 110 (FIG. 2A). The shank 164 also includes an end portion 168 adapted to engage the pad 130. The end portion 168 includes a reduced diameter section 170 and a tip 172. The tip 172 includes a base 174, a frustoconical section 176, and a wedge section 178. The frustoconical section 178 has a first angle θ1 that is selected to expand the flexible member 190 such that the flexible member 190 can slide onto the shank 164 and eventually become nested in the reduced diameter section 190. The wedge section 178 has an angle θ2 that is selected to allow a controlled wedging action between the pad 140 and the bolt 160. The base 174 is a substantially planar portion nominally seats flatly against the planar section 139B of the bearing surface 139A. As will be discussed in more detail later, the wedge section 178 enables the pad 140 to apply a predetermined supplemental gripping force on a shifting tubular member T.

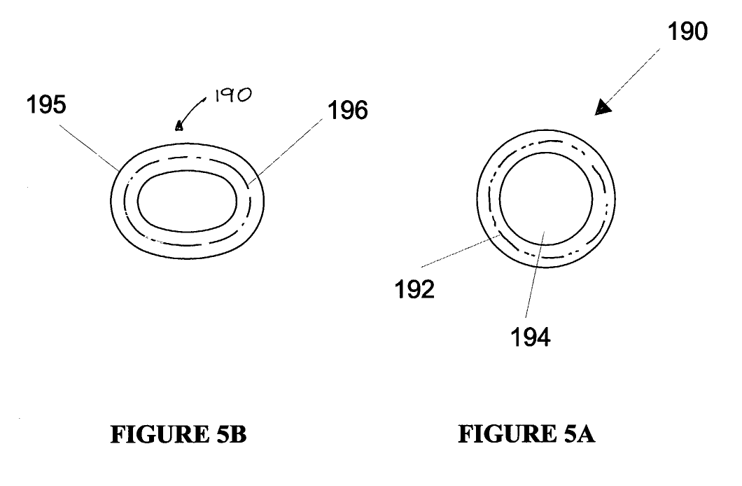

Referring now to FIGS. 3A and 5A-B, the flexible member 190 deforms to provide a selected amount of both a dampening force and a retaining force for the restraint 100. The flexible member 190 includes a deformable body 192 made of a suitable material such as rubber. The deformable nature of the body 92 performs at least two functions. First, the body 192 deforms to provide a desired amount of dampening force. In one preferred embodiment, a normally circular flexible member 190, when disposed in the chamber second portion 136, deforms to assume an elongated oval-type of shape shown in FIG. 5B. This deformation creates extended sections 195 and 196 that extend into the recess 118 of the gland 110 (FIG. 2B). Thus, the pad 130 is retained within the gland 110 because the extended sections 195 and 196 are captured within the recess 118. Additionally, these extended sections 195,196 can provide an initial or first amount of compressive (dampening) force against the interior surface 120 of the gland 110.

Referring now to FIGS. 2A and 4A, secondly, the body 192 deforms to provide a retaining force. When the bolt 160 is installed into the gland 110, the frustoconical section 176 enters a hole 194 formed in the body 192. The flexible member 190 deforms a predetermined amount to accommodate the shank 164 until the flexible member 190 reaches the reduced diameter section 170. Once the flexible member 190 nests into the reduced diameter portion 170, the flexible member 190 acts as a collar that retains the bolt 160 within the chamber second portion 136. This connection need not be permanent; i.e., the bolt 160 can be configured to disconnect from the flexible member 190 upon a predetermined amount and type of upward movement. For example, a threaded engagement can be used to selectively uncouple these components. Alternatively, threading can be used to for a partial release and a radial pulling action for a final release. This may be advantageous to prevent an unintended decoupling of the bolt 160 and the pad 130 as when the bolt 160 is rotated during an adjustment or servicing task. In addition to providing the retaining force, the diameter of the reduced diameter section 170 can be selected to provide additional expansion of the deformable body 192 and further force the extended sections 195 and 196 into the recess 118. This additional expansion can, therefore, create a supplemental dampening force between the flexible member 190 and the interior surface 120.

It should be understood that the above arrangement is merely one of numerous designs that take advantage of the teachings of the present invention. For instance, the flexible member need not be disposed within the pad. Rather, the flexible member can be fixed in the interior surface of the gland or between the gland and the pad. The flexible member can include a ring, a rod bent into a “U” shape, a two-piece member, a Teflon® spacer, a Bellville-type spring or other member having a selected amount of stiffness. Moreover, a first member (flexible or otherwise) may be used for providing a dampening force and a second member (flexible or otherwise) may be used for providing a retaining force. For example, the first member can be disposed in a groove formed in the gland and the second member can be disposed in the pad or even the bolt itself. Moreover, the materials of the first and second flexible members need not be the same. For instance, one member can be a metal-coiled spring and the second member can be an epoxy resin that “glues” or “molds” the bolt end into the pad. Furthermore, in other arrangements, the device for producing the dampening force and retaining force can be applied after assembly of the restraint. For instance, a polymer, resin or other suitable material can be “shot” down through a bore in the bolt. This material, upon flowing between the spacing in the pad and gland and setting, can provide a frictional force as well as locking the pad to the bolt.

In an alternate arrangement, the extended sections 195 and 196 enter into the recess 118 only after the flexible member 190 has engaged the bolt 160. In yet another alternate arrangement, the extended sections 195 and 196 do not provide a compressive contacting force between the flexible member 190 and the interior surface 120 until after the flexible member 190 has engaged the bolt 160. Thus, it can be seen that the dampening force and retaining force can be selectively applied to the several components of the restraint 100.

Presuming familiarity with the described embodiments of the present invention, the following description of use and operation dispenses with the numerals associated with the described features of the joint restraint. During installation of the joint restraint, the gland is placed over a tubular member (e.g., pipe). Thereafter, the bolts are advanced in a predetermined fashion to extend the pads against the surface of the tubular member. As the pads move to their extended position, their teeth penetrate and bite into the surface of the tubular member to a predetermined depth or percentage of penetration. In instances where the teeth fully penetrate the surface, the material of the tubular member will be pressed against the landings that surround the teeth.

Upon or after introduction of a pressurized fluid into the tubular member, the tubular member may shift or move axially. The axial movement of the tubular member can cause a corresponding movement of the pad. The joint restraint accommodates this motion by allowing the pad to slide about the tip of the bolt. The pad slides axially along the planar section of the pad bearing surface until the wedge section of the bolt tip engages the sloped section of the bearing surface. Additional movement by the pad causes the pad to wedge against the sloped section of the bolt tip in a controlled fashion. Thus, for example, as the pad moves axially, the wedge section urges the pad generally downward at a rate substantially corresponding to the angle or inclination of the slope portion. This downward motion can cause supplemental penetration of the teeth into the surface of the tubular member and/or generate an enhanced clamping force. It should be appreciated a plurality of pads in a joint restraint can provide this controlled wedging action simultaneously, in unison, or separately to accommodate the movement of the tubular member. Stated differently, the pads can either independently or cooperatively provide local stabilization for a shifting tubular member as well as stabilization along the full circumference of the shifting tubular member. Further, this enhanced stabilization can be permanent or temporary.

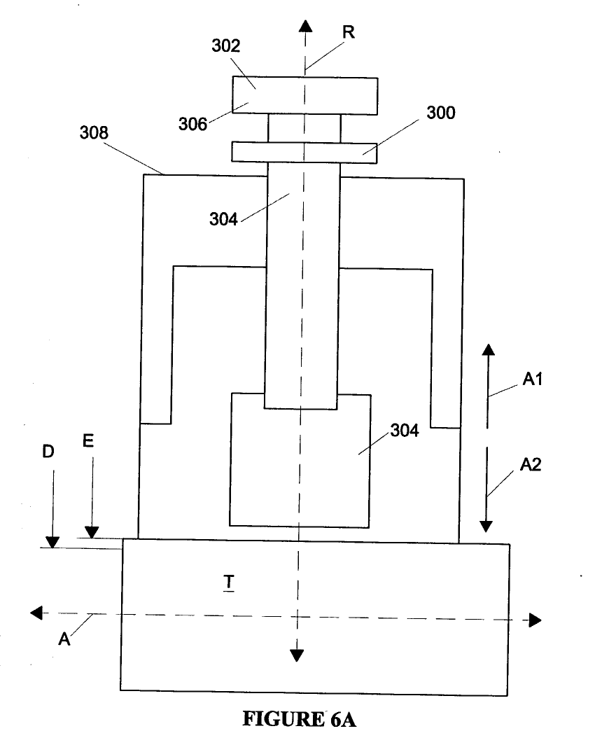

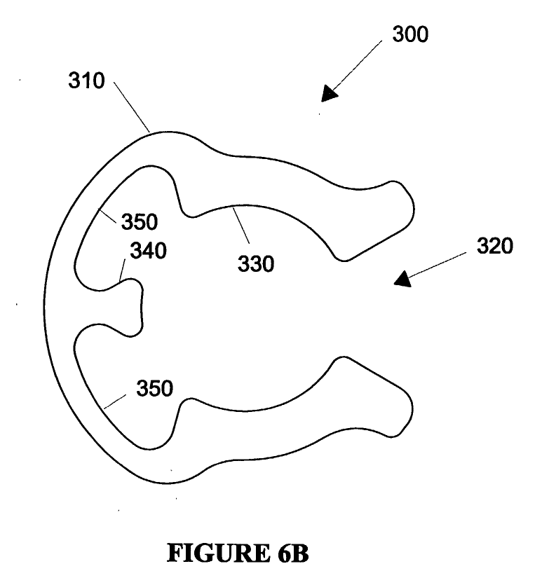

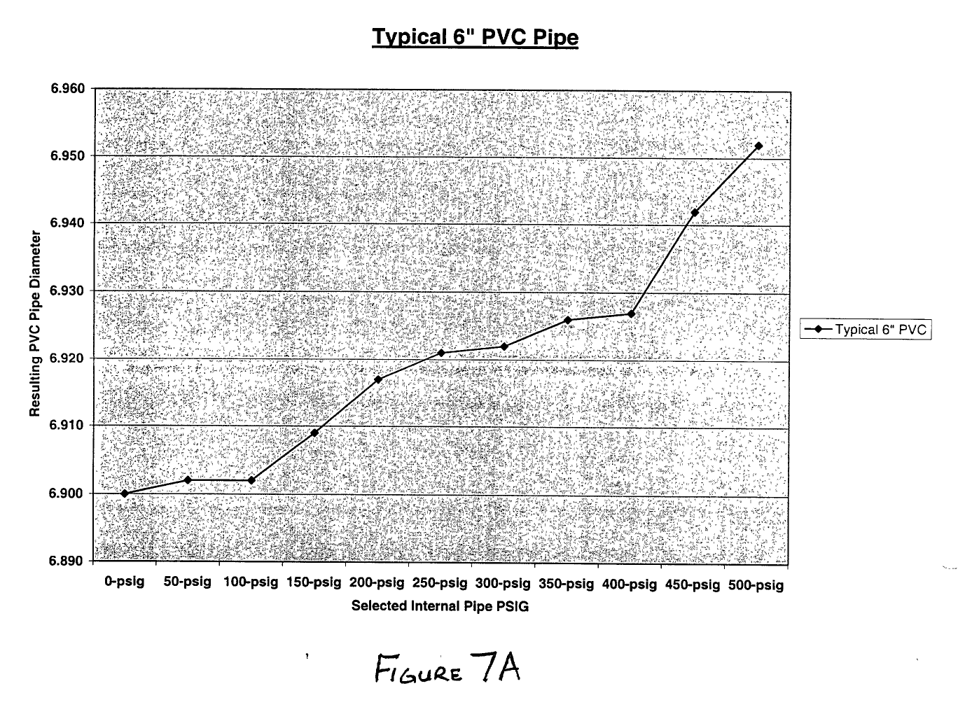

Referring now to FIGS. 6A-B, there is shown an exemplary spacer 300 made in accordance with the present invention. The spacer 300 provides enhanced control and selectivity over the clamping force generated by bolt 302. In one aspect, the spacer 300 limits the radial travel of a bolt 302 in the direction R to thereby control the degree of compression imposed on the tubular member by the pad 304. In another aspect, the spacer stabilizes the movement of the bolt 302. A preferred spacer 300 fits about a shank 304 of a bolt 302 and is interposed between a bolt shoulder 306 and a gland 308.

The preferred spacer 300 includes a resilient U-shaped ring body 310 having a mouth 320 and an opening 330. The opening 330 is diametrically sized to receive the bolt shank 304. In a preferred arrangement, the gap provided by the mouth 320 is smaller than the diameter of the shank 304. The resilient body 310, however, flexes to increase this gap and to thereby allow the shank 304 to enter or leave the opening 330. After the shank 304 enters the opening 330, the mouth 320 returns to its nominal size and captures the shank 304 within the opening 330. The spacer also includes a tab 340 for centering the shank 304 in the opening 330 and access recesses 350. The access recesses 350 accommodate tools such as a rod or screwdriver than can be used to pry the spacer 300 from the shank 304.

The body 310 further includes an outer surface for seating the bolt shoulder 306. The outer surface provides a generally flat or planar area against which the bolt shoulder applies pressure during rotation. Proper seating will, for example, increase the likelihood that sufficient torque will build up during rotation to activate known bolt torque limiting features provided on the bolt 302.

The spacer 300 has a predefined thickness TK for controlling the radial travel of the bolt. In certain embodiments, the thickness TK can be a function of the material of the tubular member. For example, it may be determined that a pipe of a first material (e.g., PVC pipe) requires a bolt to travel a radial distance of D in order for the pad teeth to properly engage the pipe surface. It may further be determined that a second material (e.g., ductile iron) of different hardness than the first material requires the bolt to travel a radial distance of E in order for proper engagement of the teeth. An exemplary spacer 300 can then be provided with a thickness of (D minus E). Thus, the spacer 300 is used when the coupling is fitted on a pipe made of the second material but removed when fitted on a pipe made of the first material. In other embodiments, the thickness TK can be made to accommodate variations or differences in the diameter of tubular members.

It should be appreciated that the spacer of the present invention may be advantageous used with the couplings made in accordance with the present invention or conventional pipe couplings.

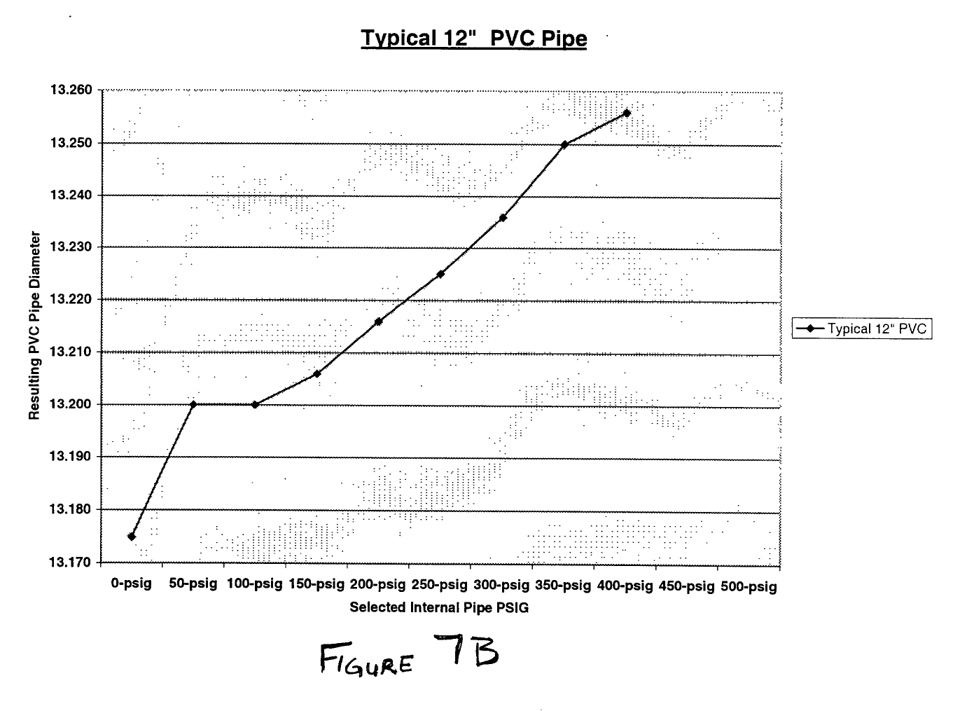

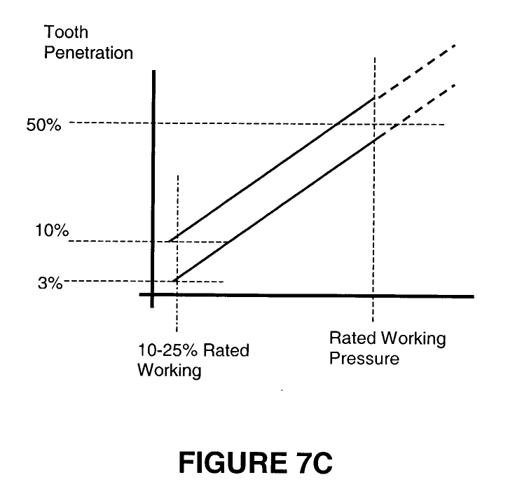

It is generally known that flexible tubular members, such as pipe formed of PVC (hereafter “PVC Pipe”), tend to swell or expand circumferentially when subjected to internal hydrostatic pressure. While even tubular members made of ductile iron also can swell under such pressure, the magnitude of this swell is substantially negligible given the dimensions of conventional pipes and associated joint restraints. For convenience, such tubular members are referred to as inflexible tubulars. For the purposes of this discussion, PVC pipe is considered exemplary of substantially flexible pipe that radially deforms an appreciable amount when exposed to internal hydrostatic pressure. The inventors of the present invention have recognized that swelling of substantially flexible pipe can be advantageously used to provide an enhanced and more reliable gripping action by a joint restraint. In order to characterize pipe swell, the inventors have conducted tests on PVC pipe. FIGS. 7A and 7B graphically illustrate certain test data relating to pressure tests conducted on sample 6″ PVC pipe and sample 12″ PVC pipe, respectively. During these tests, a PVC pipe was subjected to incremental amounts of internal hydrostatic pressure. At predetermined pressures, the outside diameter of the PVC pipe was measured.

In FIGS. 7A and 7B, the horizontal axis represents incremental pressures and the vertical axis represents the measured outside diameter of the test PVC pipe. The inventors have observed that PVC Pipe expands diametrically even at relatively low hydrostatic pressures. Furthermore, the PVC Pipe continues to diametrically expand upon incremental increases in the hydrostatic pressure. The inventors have, therefore, concluded that the diametrical expansion of PVC pipe is (a) appreciable even at relatively low hydrostatic pressures, and (b) that this diametrical expansion can be quantified or characterized. The inventors, of course, recognize that other factors can influence the diametrical expansion: e.g., wall thickness, physical properties, ambient temperature of the test sample, etc. In view of these conclusions, methods of designing and arranging a joint restraint are provided that use pipe expansion to provide an enhanced gripping action.

In one preferred method, the geometry of the pipe restraint is based on target tooth penetration at predetermined operating conditions. Referring now to FIG. 7C, there is shown a graph that illustrates one preferred relationship between joint configuration and working pressure. In the FIG. 7C arrangement, it is preferred that a tooth on a pad penetrate at least 3% into a PVC Pipe but no more than 10% at 10%-25% percent of a rated working pressure. For many applications, a tooth penetration of about 50% into the tubular member at the rated working pressure is believed to be adequate. However, it is believed that tooth penetration at rated working pressure between about 30%-70% will also be adequate in most instances. Under conventional arrangements, the maximum rate of pressure of a PVC Pipe may be several multiples of the rated working pressure. Accordingly, it is preferred that a certain amount of penetration be provided for in the event that the hydrostatic pressure exceeds the rated working pressure.

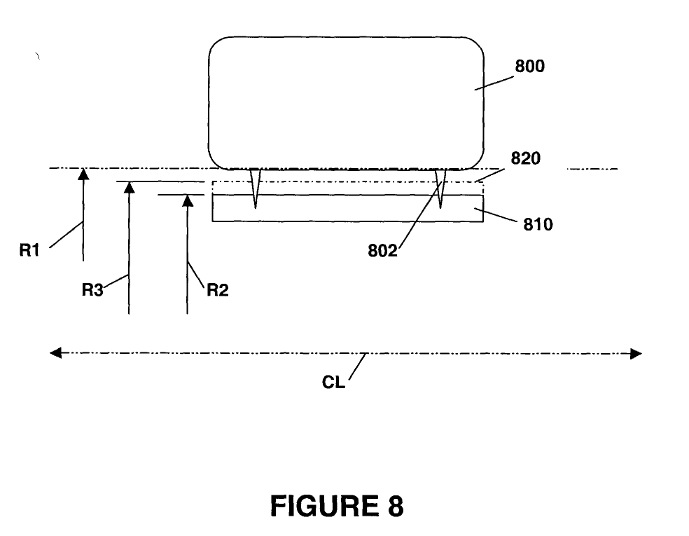

Referring now to FIG. 8, there is schematically illustrated an exemplary pad 800 having a tooth 802 positioned over a section of flexible pipe 810. The flexible pipe 810 has an axial center line designated CL. Numerals R1, R2 and R3 represent radial distances from the centerline CL. Numeral R1 represents the operational radial location of the pad 800 during use. Numeral R2 represents the nominal radius of the outside surface of the flexible pipe 810 before the application of hydrostatic pressure. Reference Numeral R3 represents the expanded radius of the flexible pipe (shown as a hidden figure labeled 820). In accordance with one embodiment of the present method, a target percentage penetration is set for the joint restraint, for example 50%, at rated working pressure. Reference to pressure versus circumferential expansion charts will provide the expanded diameter R3 at the rated pressure. With R3 established, a length for the tooth or teeth can be selected (for example 0.0080). Because 50% tooth penetration is desired, 0.0040 inches of the tooth will remain outside of the tube surface. Thus, the length of the exposed tooth when added to R3 generally provides the value of R1. Thus, it can be seen that the tendency for flexible pipe to swell or circumferentially expand can be integrated into the gripping mechanism employed by a joint restraint.

It should be understood that the terms “circumferential expansion,” “diametrical expansion,” and “radial expansion” are used interchangeably to describe the swelling of a flexible member.

The foregoing description is directed to particular embodiments of the present invention for the purpose of illustration and explanation. It will be apparent, however, to one skilled in the art that many modifications and changes to the embodiment set forth above are possible without departing from the scope and the spirit of the invention. It is intended that the following claims be interpreted to embrace all such modifications and changes.

We claim:

1. An apparatus for restraining at least two members, comprising:
(a) a gland having a pocket;
(b) a pad disposed in said pocket, said pad having a first state wherein said pad is retracted within said pocket, and a second state wherein said pad is at least partially extended out of said pocket;
(c) a dampening device associated with said pad, said dampening device providing a substantially persistent dampening force for reducing relative movement between said gland and said pad while said pad is in said first state; and
(d) a bolt having an end engaging said pad, said bolt adapted to move said pad between said first and second states.

2. The apparatus according to claim 1 wherein said dampening force is selected from a group consisting of a locking force, a frictional force, and a chemical force.

3. The apparatus according to claim 1 wherein said dampening device comprises a first member disposed in said pocket for providing said dampening force, said first member releasably retaining said pad in said pocket while said pad is in said first state.

4. The apparatus according to claim 3 wherein said first member further provides a retaining force for engaging said bolt end to said pad.

5. The apparatus according to claim 3 wherein said gland pocket has a recess portion for receiving said first member.

6. The apparatus according to claim 3 wherein said first member includes at least a deformable material at least partially compressively interposed between said gland and said pad.

7. The apparatus according to claim 3 wherein said first member is substantially fixed within one of said gland and said pad.

8. The apparatus according to claim 3 wherein said first member comprises a deformable ring; and said pad includes a channel for receiving said deformable ring.

9. The apparatus according to claim 8 wherein said deformable ring has a first portion for engaging said bolt end and a second portion retained in said channel, said bolt thereby being engaged to said pad.

10. The apparatus according to claim 8 wherein said first member provides a dampening force only after said bolt engages said first portion of said ring.

11. The apparatus according to claim 8 wherein said first member provides increased dampening force after said bolt engages said first portion of said ring.

12. The apparatus according to claim 3 further comprising a second member connecting said bolt end to said pad.

13. The apparatus according to claim 1 wherein said dampening force does not physically connect said pad to said gland

14. The apparatus according to claim 1 wherein said dampening force is selected from a group consisting of a magnetic force and a vacuum force.

15. The apparatus according to claim 1 wherein a second dampening force reduces relative movement between said gland and said pad when said pad is in said second state.

16. A method for controlling relative movement between a pad and a gland of a joint restraint, comprising:
(a) providing a substantially persistent dampening force for reducing relative movement between the gland and the pad while the pad is in a retracted state.

17. The method according to claim 16 wherein the dampening force is selected from a group consisting of a locking force, a frictional force, and a chemical force.

18. The method according to claim 16 further comprising releasably retaining the pad in the gland with a first member while the pad is in the retracted state.

19. The method according to claim 18 wherein the first member provides the dampening force.

20. The method according to claim 18 wherein the first member further provides a retaining force for engaging a bolt end to the pad.

21. The method according to claim 18 wherein the first member includes at least a deformable material at least partially compressively interposed between the gland and the pad.

22. The method according to claim 18 wherein the first member comprises a deformable ring.

23. The method according to claim 18 further comprising providing the dampening force only after a bolt engages the first member.

24. The method according to claim 18 further comprising providing increased dampening force after the bolt engages the first member.

25. The method according to claim 18 further comprising connecting the bolt to the pad with a second member.

26. The method according to claim 16 further comprising dampening relative movement between the gland and the pad when the pad is at least partially extended out of the gland.
